(19) United States
(12) Patent Application Publication
(10) Pub. No.: US 2005/0213851 A1
(43) Pub. Date: Sep. 29, 2005

(54) SCALING DEVICE AND METHOD FOR SCALING A DIGITAL PICTURE

(76) Inventor: Wen-Kuo Lin, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,779

(22) Filed: Mar. 25, 2004

(51) Int. Cl. G06K 9/40

(52) U.S. Cl. 382/298

(57) ABSTRACT

A scaling device and method for scaling a digital picture in only one pass requires only a small amount of buffer memory which can be used in real time. The method includes inputting the digital picture, generating a block of the digital picture from the digital picture, creating two weighting matrices, and multiplying the block of the digital picture by the weighting matrices.

### BACKGROUND OF INVENTION

1. Field of the Invention

The present invention relates to a scaling device and method for scaling a digital picture, and more particularly, to a scaling device and method for scaling a digital picture where the horizontal-scaling and vertical-scaling processes to be performed in one-pass and only uses a small amount of buffer memory.

2. Description of the Prior Art

The conventional method of digital picture scaling is to separate a 2 dimensional (2D) scaling process into two 1D-scaling processes. In other words, the scaling process is first to be performed on the horizontal direction (width) and then on the vertical direction (height).

Theoretically, the method to perform 1D-scaling process is to exploit the sampling formula for a new sampling point by the following equation:

$$x ( t ) = {\sum }_{n = - i}^{j} x ( n ) h ( t - n ) \qquad ( 1 )$$

where x(t) is the pixel value at a new sampling point t from n=0 and the range of t is 0<t<1, x(n) is the original pixel value at index n, and h(t−n) is the value of an interpolation function inversed and shifted by t from index n. Furthermore, the coefficients i and j give the number of original pixels involved in interpolating x(t), i.e. the number of original pixels involved is given by (i+j) which gives the number of filter taps needed and h(n) is the tap weighting at index n.

The conventional scaling method has two drawbacks. First, the two-pass process of the conventional scaling method is not suitable for real-time applications, because the vertical scaling process cannot be performed until the horizontal scaling process has been accomplished, or vice versa. Furthermore, due to the two-pass process, the conventional scaling method requires a buffer memory to store the results from the horizontal scaling, as well as to provide the freedom to use interpolation filters of any length to achieve the required scaling quality.

FIG. 1 shows the conceptual diagram for the up-scaling process, where W_{old} and H_{old} are the old width and the old height of the original digital image, and W_{new} and H_{new} are the new width and new height of the image after scaling. The buffer memory is required to store the results from scaling the pictures horizontal dimension and the size of the buffer is (W_{old}×H_{old}) bytes.

There are multiple drawbacks in the conventional scaling method especially when up-scaling an input picture. Assume the input source image is to be up-scaled to two times larger in each direction, the buffer memory required becomes (W_{new}×H_{new})=2×(W_{old}×H_{old}). Furthermore the delay time of the conventional scaling method is not feasible for some applications. In particularly, the high memory requirement is not suitable for the hardware implementation by integrated circuits (ICs) and the high data delay time is not suitable for real time applications.

To solve the aforementioned problems, the common practice is to trade the vertical scaling quality with low-buffer-memory solutions, which in turns reduces the data delay time. For example, the vertical scaling process uses only a two-tap filter so that only a two-line buffer needs to be maintained. However, the small buffer limits the scaling quality and a device and method for high quality scaling in real time using little memory is needed.

### SUMMARY OF INVENTION

It is therefore an advantage of the claimed invention to provide a scaling device and method to solve the aforementioned problems.

According to the claimed invention, the scaling device for scaling a digital picture comprises a source buffer for storing the digital picture, a processing unit for creating two weighting matrices, an intermediate buffer for storing output data generated by multiplying a block of the digital picture by one of the weighting matrices, and a destination buffer for storing output data generated by multiplying the output data stored in the intermediate buffer by the other weighting matrix.

Further, the method for scaling a digital picture which has a plurality of blocks comprises inputting the digital picture, creating two weighting matrices, and multiplying the plurality of blocks of the digital picture by the weighting matrices.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a prior art scaling method.

FIG. 2 is a conceptual diagram of a scaling method according to the present invention.

FIG. 3 is a flowchart for creating a weighting matrix according to the present invention.

FIG. 4 is a flowchart of the scaling method in FIG. 2.

FIG. 5 is the segmented flowchart for initialization of the scaling method according to one embodiment of the present invention.

FIG. 6A is the segmented flowchart for vertical scanning of the scaling method according to one embodiment of the present invention.

FIGS. 6B and 6C show boundary conditions of different options according to the present invention.

FIG. 7 is the segmented flowchart for horizontal scanning of the scaling method according to one embodiment of the present invention.

FIG. 8 is the segmented flowchart for performing the scaling method according to one embodiment of the present invention.

FIG. 9 is a block diagram of a scaling device for scaling a digital picture according to one embodiment of the present invention.

FIG. 10 is a schematic diagram of the processing unit in FIG. 9 for performing the matrix multiplication of the present invention.

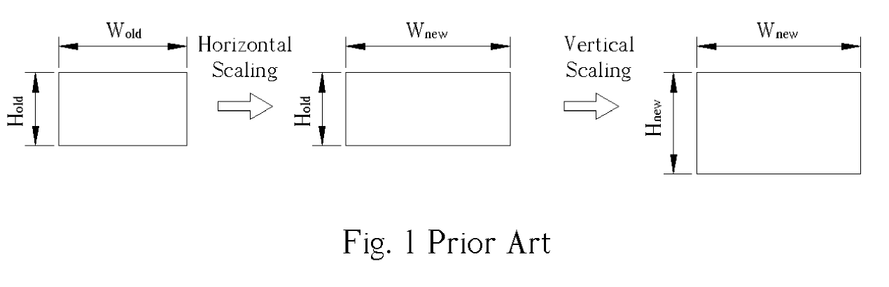

### DETAILED DESCRIPTION

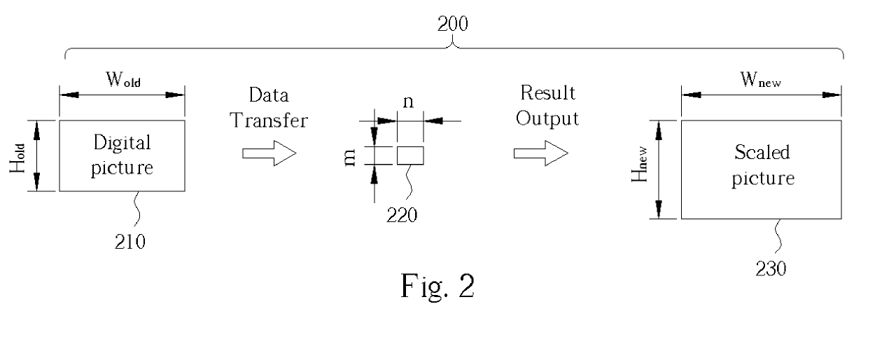

FIG. 2 shows a conceptual diagram of a scaling method 200 of the present invention applied for the up-scaling process. In the method 200, a digital picture 210 with a dimension of Hold-by-Wold is first received. The digital picture 210 is filtered by an interpolation filter with a length of m used for vertical scaling and by an interpolation filter with a length of n used for horizontal scaling to sequentially generate a plurality of blocks 220 each having a size of m-by-n. Each of the blocks 220 is multiplied by two weighting matrices to form a scaled picture 230 with a dimension of H_{new}-by-W_{new}. The same concept can also be adapted for the case of the down-scaling process.

The present invention reduces the complexity of implementing Eq. 1. This invention exploits two weighting matrices to store the weights of filter taps. These weights are pre-calculated at the precision that is adjustable to match the requirement of different systems. In other words, the range of t in Eq. 1 is divided into a number of segments and each segment represents all the sampling points that fall into this segment range. Furthermore, this invention provides the freedom to use a variable number of filter taps that also depends on the system requirement. As a result, if the system implementing this invention requires high precision, the range of t can be finely divided into a large number of segments and more number of filter taps can be used. On the other hand, if the system has a constrained resource, then the range of t can be divided into a smaller number of segments and fewer number of filter taps can be used.

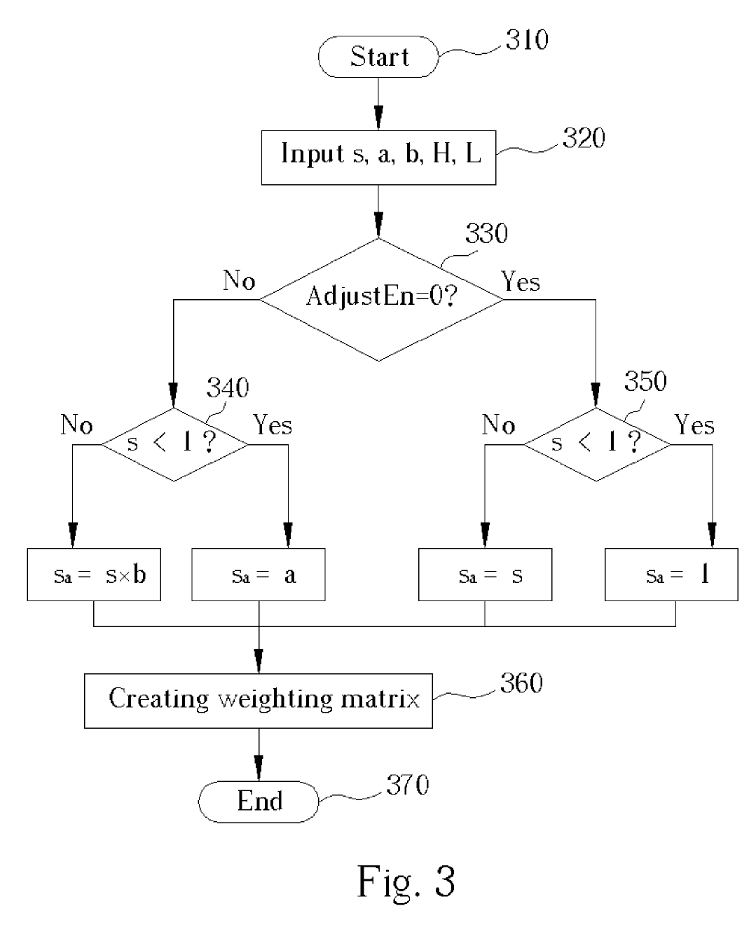

FIG. 3 shows a flowchart of creating a weighting matrix. Assuming the range of t is divided into H segments, the number of filter taps is L, the scaling factor is s, and two weight factors are a and b. In Step 320, s, a, b, H and L are inputted. In step 330, if the scaling adjusting factor flag AdjustEn=0 (disable), then in step 350 if s<1, the adjusted scaling factor sₐ=1, otherwise sₐ=s. Whereas, if AdjustEn=1 (enable), then in step 340 if s<1, the adjusted scaling factor sₐ=a, otherwise sₐ=s*b. In step 360, the weighting matrix WeightMat is generated as

$$WeightMat ( i , j ) = \frac{w ( i , j )}{W ( i , j )}$$

where i ranges from 0 to (H−1), j ranges from 0 to (L−1), w(i,j) is the pre-normalized weighting at (i,j), and W(i,j) is the normalization factor given by

$$W ( i , j ) = {\sum }_{j = 0}^{L - 1} w ( i , j )$$

The pre-normalized weighting w(i,j) is given by

$$w ( i , j ) = h ( \frac{p - j + \frac{i}{H}}{{S}_{a}} )$$

where h(s) is an interpolation filter, p=L/2−1, H is the number of segments of t, and sₐ is the adjusted scaling factor.

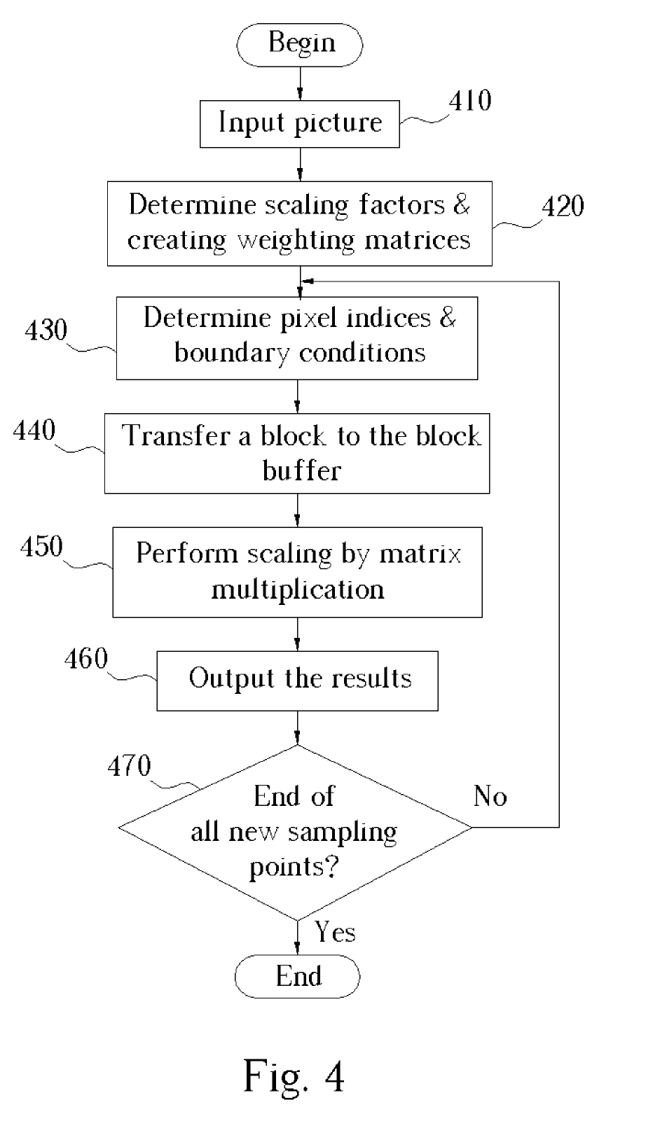

FIG. 4 shows a flowchart of the scaling method of the present invention. In step 410, the digital picture 210 is inputted and stored in a source buffer. The size of the source buffer is at least the size of the width of the digital picture 210 times the height of the digital picture 210. In step 420, the horizontal and vertical scaling factors are determined from the final required image dimension of the user. The user enters the required image dimension and the scaling factors are automatically determined by dividing the width and height of the digital picture 210 by the width and height of the scaled picture 230 respectively. With the scaling factors, two weighting matrices are generated according to the flowchart in FIG. 3. In step 430-450, the new sampling points are scanned according to the scaling factors. The scanning of the new sampling points at those new sampling points includes the following steps: in step 430, determining the indices of pixels used for interpolation and adjusting those indices according to the boundary conditions; in step 440, transferring a block 220 of the digital picture 210 to the block buffer according to the indices; in step 450, performing horizontal and vertical scaling by matrix multiplications; and outputting results to a destination buffer in step 460. Finally in step 470, these steps 430-460 are repeated until all the new sampling points have been generated. If all the new sampling points are generated, the flow ends. If not all the new sampling points are generated, the flow reverts to step 430 and repeats steps 430-450.

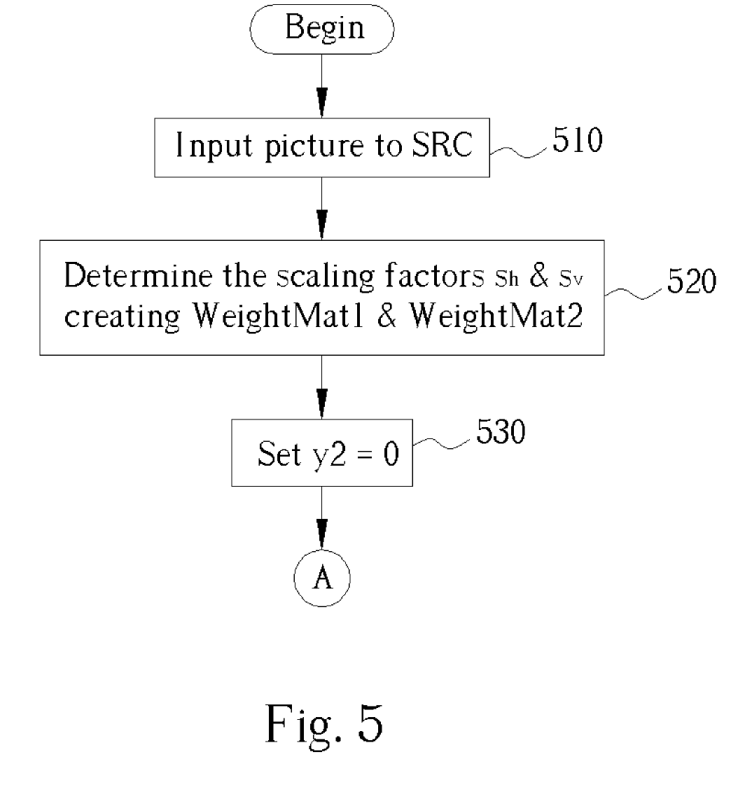

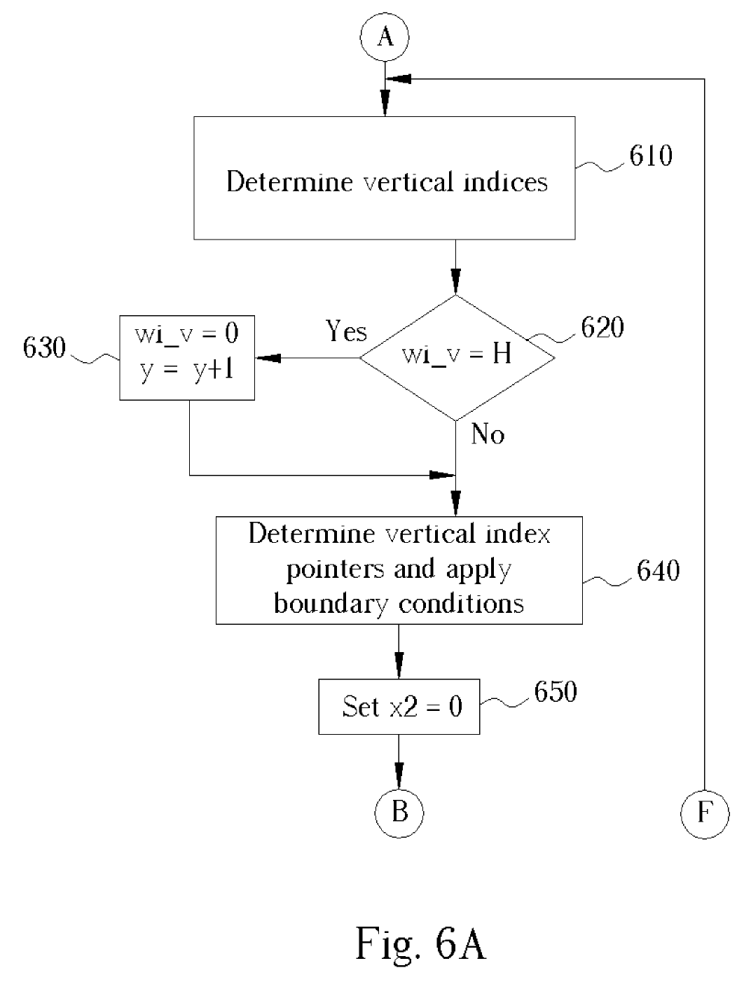

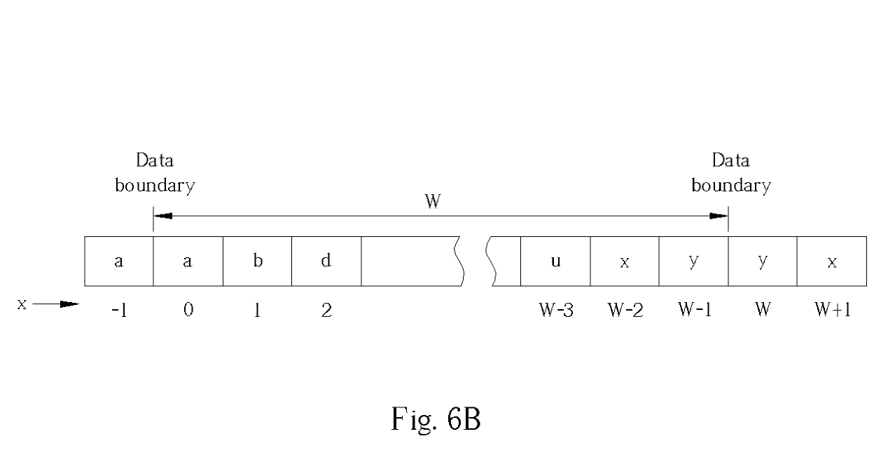

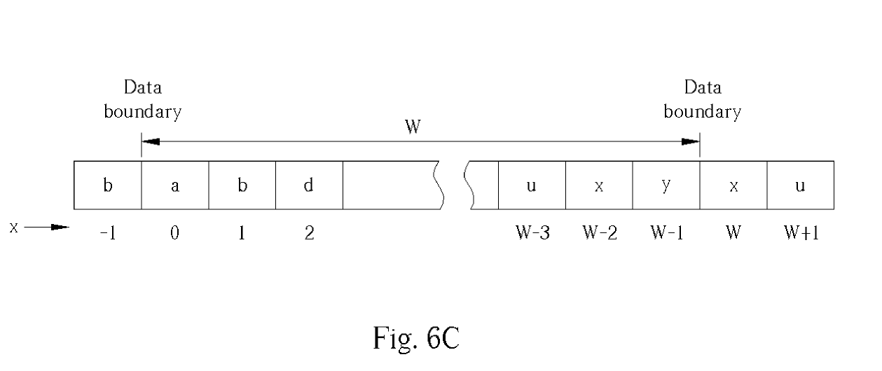

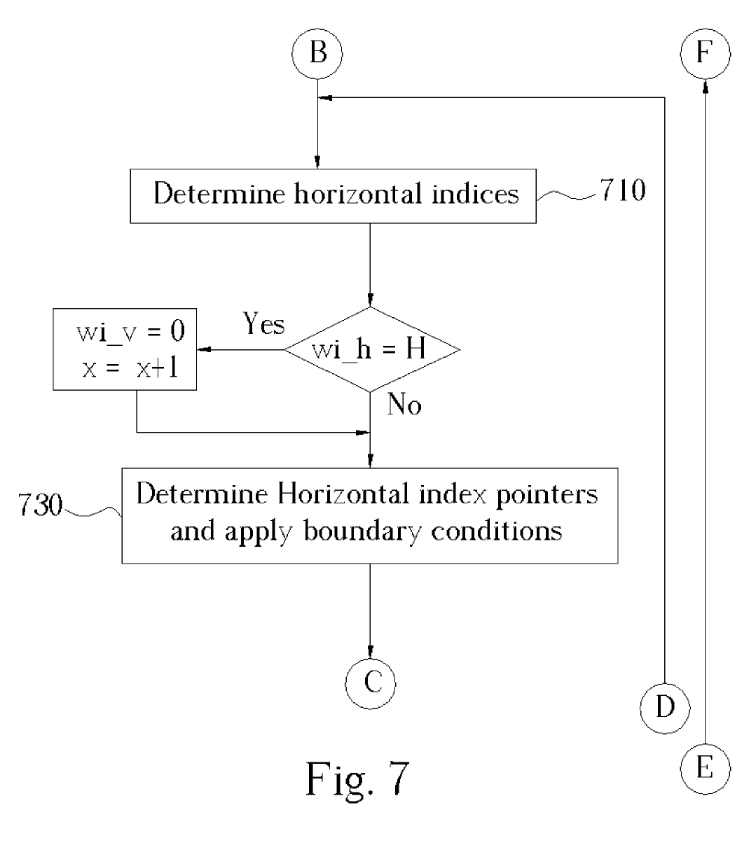

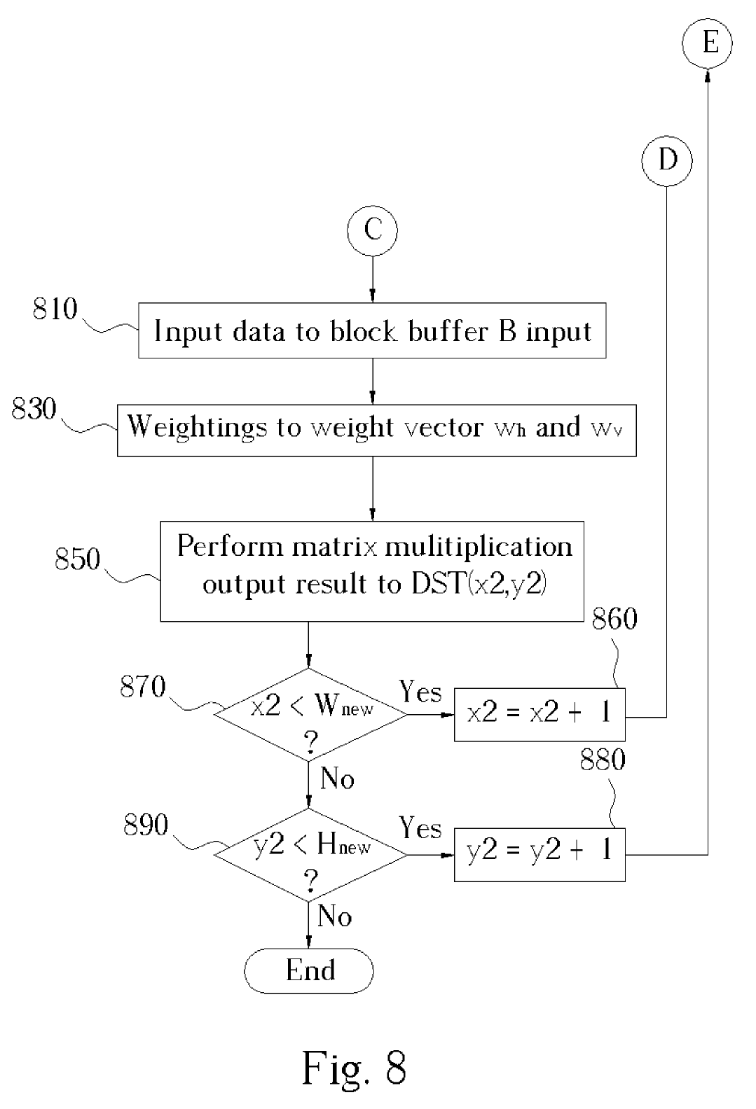

The preferred embodiment of the present invention chooses 16 segments (i.e. H=16) and 4 filter taps (i.e. L=4) for demonstrating the best mode of the present invention. However the number of segments and filter taps is merely a design choice and presents no limitation in any way to the present invention. The detailed flowchart of the present invention is divided into 3 separate parts which are the initialization in FIG. 5, the vertical scaling in FIG. 6A, the horizontal scaling in FIG. 7, and finally, FIG. 8.

Please refer to FIG. 5, the initialization process begins with first inputting the digital picture 210 into a source buffer SRC in step 510. The size of the digital picture 210 is denoted by W_{old} and H_{old} and the size of the source buffer SRC should be sufficient to accommodate the digital picture 210. In step 520, the user enters the required new image size W_{new} and H_{new} and the horizontal and vertical scaling factors are respectively determined by the following equations.

$${S}_{k} = \frac{{W}_{old}}{{W}_{new}} and {S}_{v} = \frac{{H}_{old}}{{H}_{new}}$$

where W_{old} and H_{old} are respectively the width and height of the digital picture 210 and W_{new} and H_{new} are respectively the width and height of the scaled picture 230. Once the scaling factors are determined, the horizontal and vertical weighting matrices WeightMat1 and WeightMat2 are generated according to the flowchart in FIG. 3 with the formulas given earlier. In the present embodiment, the size of both the WeightMat1 and WeightMat2 is 16×4 because H=16 and L=4. It is to be noted that the size of the weighting matrices is dependent on the required resolution which can be adjusted by changing the values of H and L. A larger H value means the range of t is divided into more segments which means that the resolution of the scaling is higher. A larger L value corresponds to a greater number of filter taps, which means more surrounding pixels are referenced. In creating the WeightMat1 and WeightMat2, the scaling factor adjusting flag AdjustEn is either set to 0 (disable) or 1 (enable) depending on the application. At the end of the initiation process in step 530, a new vertical index y2 is first set to 0 before the vertical scaling begins. The flowchart in FIG. 5 connects to a junction A which reappears in FIG. 6A used only to illustrate the continuity of the entire process.

Please refer to FIG. 6A, which shows the vertical scanning process. The flowchart is a continuation from FIG. 5 through junction A. In step 610, the relationship between an old vertical index y1 of the input source image and the new vertical index y2 of the scaled image is defined by the following equation:
y1=sᵥ*y2
y=floor(y1)
wi_v=round[(y1−y)xH]
where sᵥ is the vertical scaling factor, y2 is the new vertical index of the scaled image, y1 is the old vertical index of the input source image that corresponds to y2, y is the integer part of y1, wi_v is the index to extract filter tap weightings from WeightMat1 for the vertical scaling process. The function floor ( ) and round ( ) are a flooring process and rounding process respectively. The flooring process takes the old vertical index and sets it as the current vertical index y for calculation purposes. The rounding process takes the decimal answer from the calculation and rounds off to the closest integer value. In step 620, a safely check is performed to determine if wi_v equals to H because when such happens the pointer wi_v exceeds the valid range of 0 to H−1 so no weighting values are able to be fetched. If wi_v=H, the flowchart sidetracks to step 630 to reset the value of wi_v to 0 and increment the value of the current vertical index by 1 to continue with the vertical scaling process. If wi_v is not equal H, the flowchart proceeds to step 640 where the vertical index pointers are determined from the inputted source image and according to the number of filter taps. In this embodiment, the number of filter taps is 4 so there are 4 vertical index pointers which are i0, i1, i2, and i3. The 4 vertical index pointers are respectively set based on the boundary conditions which are generalized by the following general formulas: i[p+abs(p0)]=((x+p)*e+S*a+((W−1)−d+S)*b)*((−1)\hat{ }a), where i[n] is the data retrieval for tap number n and n ranges from 0 to L−1, and W is the data length. The other parameters are given as

$$n = p + abs ( p 0 ) , \\ p 0 = - ( L / 2 - 1 ) , \\ p 1 = L / 2 , \\ a = sign ( x + p ) , \\ b = sign ( ( W - 1 ) - ( x - p ) ) , \\ c = W - 1 - x , \\ d = x + p - ( W - 1 ) , \\ e = Not ( b ) \& 1 , \\ S = 0 or 1.$$

$$sign ( X ) = \{ \begin{matrix}1 , & X < 0 ; \\ 0 , & X >= 0.\end{matrix}$$

Function abs(X) gives the absolute value of X.

Function Not(X) is a bit-wise operation and inverts the binary bits, ie.
Not(0)=1 and Not(1)=0.

One should note that although parameters a and b used here are the same as those in FIG. 3, they represent different meaning.

The vertical index pointers are created from the current vertical index according to the boundary conditions of option 1. In this embodiment,
If y=0, then i0=y, i1=y, i2=y+1, and i3=y+2
If y=H_{old-}2, then i0=y−1, i1=y, i2=y+1, and i3=y+1
If y=H_{old}−1, then i0=y−1, i1=y, i2=y, and i3=y−1
Otherwise, i0=y−1, i1=y, i2=y+1, and i3=y+2

After all the vertical index points are determined, step 640 ends and step 650 follows to set x2 to 0. The flowchart in FIG. 6A connects to a junction B which reappears in FIG. 7 used only to illustrate the continuity of the entire process. Junction F in FIG. 6A represents an action reverted back from FIG. 7 as part of the loop. Vertical scanning of the source image to generate vertical index pointers is completed.

Please refer to FIG. 7 which shows the horizontal scanning process. The flowchart is a continuation from FIG. 6A through junction B. The horizontal scanning process is identical to the vertical scanning process so the detailed description can be referred to the vertical scanning process.
x1=sₕ*x2
x=floor(x1)
wi_h=round[(x1−x)xH]
   where sₕ is the horizontal scaling factor, x2 is the new horizontal index of the scaled image, x1 is the old horizontal index of the input source image that corresponds to x2, x is the integer part of x1, wi_h is the index to extract filter tap weightings from WeightMat2 for the horizontal scaling process.

The horizontal index pointers are created from the current horizontal index according to the boundary conditions. In this embodiment,
If x=0, then i0=x, i1=x, i2=x+1, and i3=x+2
If x=W_{old}−2, then i0=x−1, i1=x, i2=x+1, and i3=x+1
If x=W_{old}−1, then i0=x−1, i1=x, i2=x, and i3=x−1
Otherwise, i0=x−1, i1=x, i2=x+1, and i3=x+2

After all the horizontal index points are determined, step 730 is finished and the horizontal scanning is completed. The flowchart in FIG. 7 connects to a junction C which reappears in FIG. 8 used only to illustrate the continuity of the entire process. Horizontal scanning of the source image to generate horizontal index pointers is completed.

Please refer to FIG. 8, which shows the engine for performing the scaling method of the present invention. In step 810, data of the segments that are defined by the first block according to the vertical index pointers and the horizontal index pointers is transferred to the block buffer B for processing. In this embodiment, the number of filter taps is chosen to be 4 for both the vertical filter taps and the horizontal filter taps. Therefore the buffer size is 4×4 which equals 16 pixel-unit. If each pixel is 1 byte, the size of the block buffer is 16 bytes. The block buffer B can be implemented in many different ways according to the system requirement but common buffer memory comprises DRAM, SDRAM, flash memory, and the like in DSCs and comprises registers made by flip-flops, register-file (RF), and the like in ICs. Furthermore the 2D block buffer can be implemented by a 1D line buffer by using proper indexing method to mimic a 2D block buffer. The block of data is transferred to the block buffer B according to the vertical index pointers and the horizontal index pointers. The matrix of data in the block buffer is as follow:
B(0,0)=SRC(j0,i0) B(1,0)=SRC(j1,i0) B(2,0)=SRC(j2,i0)
B(3,0)=SRC(j3,i0)
B(0,1)=SRC(j0,i1) B(1,1)=SRC(j1,i1) B(2,1)=SRC(j2,i1)
B(3,1)=SRC(j3,i1)
B(0,2)=SRC(j0,i2) B(1,2)=SRC(j1,i2) B(2,2)=SRC(j2,i2)
B(3,2)=SRC(j3,i2)
B(0,3)=SRC(j0,i3) B(1,3)=SRC(j1,i3) B(2,3)=SRC(j2,i3)
B(3,3)=SRC(j3,i3)

In step 830, the filter weightings are transferred respectively from WeightMat1 and WeightMat2 to create two vectors Wᵥ and Wₕ using index wi_v and wi_h.

The values of Wᵥ are created according to the following:
Wᵥ(0)=WeightMat1(wi_v, 0)
Wᵥ(1)=WeightMat1(wi_v, 1)
Wᵥ(2)=WeightMat1(wi_v, 2)
Wᵥ(3)=WeightMat1(wi_v, 3)
   and the values of Wₕ are created according to the following:
Wₕ(0)=WeightMat2(wi_v, 0)
Wₕ(1)=WeightMat2(wi_v, 1)
Wₕ(2)=WeightMat2(wi_v, 2)
Wₕ(3)=WeightMat2(wi_v, 3)

After the corresponding data is entered in the block buffer B and the vectors Wᵥ and Wₕ are created, in step 850, a matrix multiplication of the data in the block buffer B and both the vectors Wᵥ and Wₕ is performed. The Wᵥ is dot multiplied by the matrix of data in the block buffer B and dot multiplied by the Wₕ. The output of the matrix multiplication is a 2D result which is stored in the destination buffer DST. The mathematical formula below shows that how the values in the destination buffer DST is calculated from the block buffer.

$$DST ( x 2 , y 2 ) = {W}_{v} {BW}_{h} \\ [ {w}_{v} ( 0 ) {w}_{v} ( 1 ) {w}_{v} ( 2 ) {w}_{v} ( 3 ) ] \cdot [ \begin{matrix}B ( 0 , 0 ) & B ( 1 , 0 ) & B ( 2 , 0 ) & B ( 3 , 0 ) \\ B ( 0 , 1 ) & B ( 1 , 1 ) & B ( 2 , 1 ) & B ( 3 , 1 ) \\ B ( 0 , 2 ) & B ( 1 , 2 ) & B ( 2 , 2 ) & B ( 3 , 2 ) \\ B ( 0 , 3 ) & B ( 1 , 3 ) & B ( 2 , 3 ) & B ( 3 , 3 )\end{matrix} ] \cdot [ \begin{matrix}{w}_{k} ( 0 ) \\ {w}_{k} ( 1 ) \\ {w}_{k} ( 2 ) \\ {w}_{k} ( 3 )\end{matrix} ]$$

where DST(x2,y2) is the output picture memory buffer and DST(x2,y2) is the interpolated pixel value at coordinates (x2,y2). A checking process is performed to determine if the scaling process is completed by determining if the new horizontal index x2 is smaller than the W_{new} in step 870 and if the new vertical index y2 is smaller than the H_{new} in step 890. If the value of x2 is smaller than the W_{new}, the flow proceeds to step 860 where x2=x2+1 and reverts back to step 710. Similarly, if the value of y2 is smaller than the H_{new}, the flow proceeds to step 880 where y2=y2+1 and reverts back to step 610 in FIG. 6A.

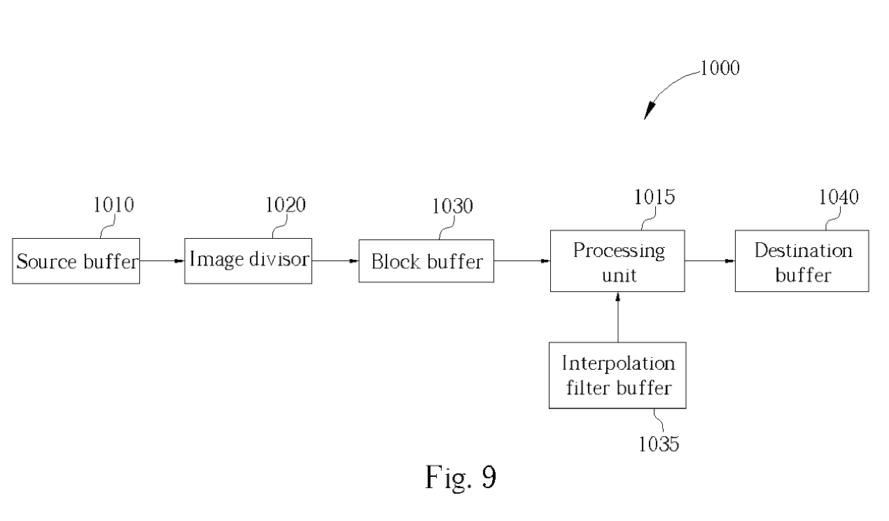

Please refer to FIG. 9, which shows a block diagram of scaling device 1000 for scaling a digital picture according to the present invention. The scaling device 1000 comprises a source buffer 1010 for storing a digital picture, a processing unit 1015 for creating two weighting matrices, and an image divisor 1020 for filtering the digital picture to generate a plurality of blocks of the digital picture, a block buffer 1030 for sequentially storing the plurality of blocks of the digital picture generated by the image divisor 1020, an weighting matrix buffer 1035 for storing the weighting matrices, and a destination buffer 1040 for storing the scaled digital picture.

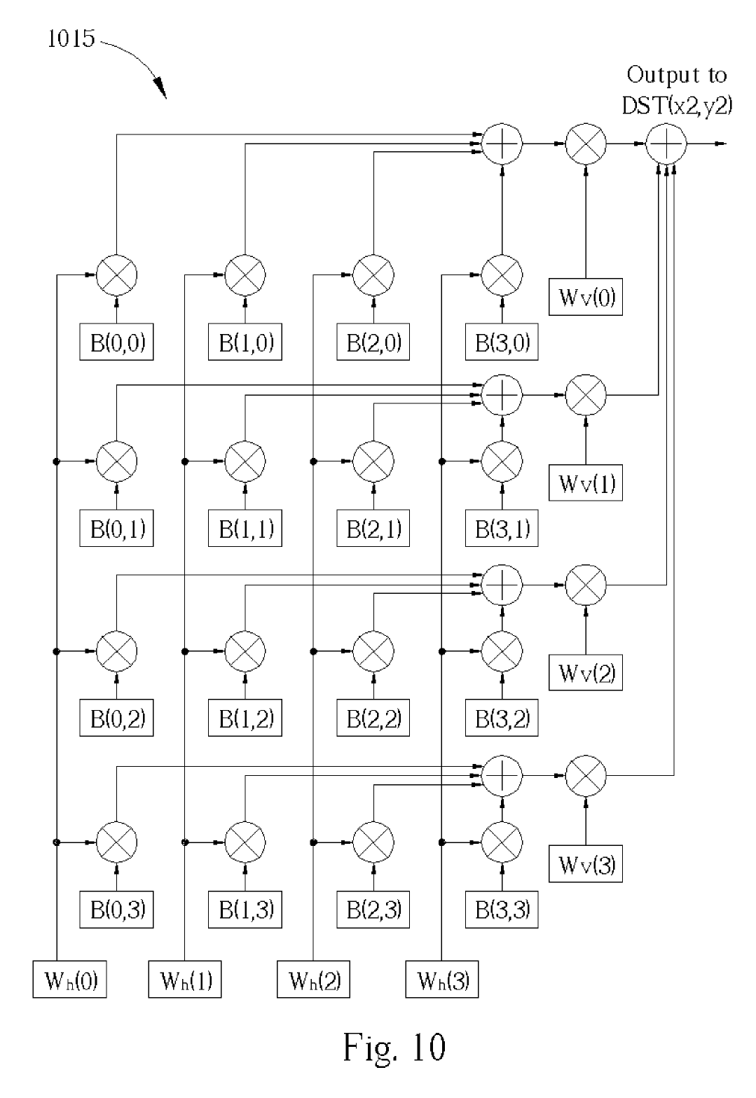

Please refer to FIG. 10, which shows a schematic diagram of the processing unit 1015 in FIG. 9 for performing the matrix multiplication of the present invention. The processing unit 1015 comprises a plurality of multipliers and adders electrically coupled to the block buffer 1030. Each data unit in the block buffer 1030 is electrically coupled to a multiplier which is further electrically coupled to receive Wₕ. The data units in the first column of the data in the block buffer B where i=0 are electrically multiplied by Wₕ(0), the data units in the second column of the data in the block buffer B where i=1 are electrically multiplied by Wₕ(1), the data units in the third column of the data in the block buffer B where i=2 are electrically multiplied by Wₕ(2), and the data units in the fourth column of the data in the block buffer B where i=3 are electrically multiplied by Wₕ(3). The outputs from the multipliers are electrically coupled to an adder before being sent to another multiplier to perform the multiplication with Wᵥ. The output from the multipliers are taken row by row, where the data units in the first row of the data in the block buffer B where j=0 are electrically are multiplied by Wᵥ(0), the data units in the first row of the data in the block buffer B where j=1 are electrically are multiplied by Wᵥ(1) the data units in the first row of the data in the block buffer B where j=2 are electrically are multiplied by Wᵥ(2), and the data units in the first row of the data in the block buffer B where j=3 are electrically are multiplied by Wᵥ(3).

Compared with the prior art, the buffer memory can be greatly reduced even when up-scaling a digital picture. Further, the vertical and horizontal scaling processes are performed for each block before scaling another block thus allowing for real-time applications. Moreover, one should note that the present invention can be applied to pictures with a single color component and pictures with multiple color components.

Those skilled in the art will readily observe that numerous modifications and alterations of the device may be made while retaining the teachings of the invention. Accordingly, that above disclosure should be construed as limited only by the metes and bounds of the appended claims.

1. A method for scaling a digital picture, the method comprising following steps:
(a) inputting the digital picture;
(b) generating a block of the digital picture from the digital picture;
(c) creating two weighting matrices; and
(d) multiplying the block of the digital picture by the weighting matrices.

2. The method of claim 1 wherein step (b) comprises filtering the digital picture with interpolation filters to generate the block of the digital picture.

3. The method of claim 2 wherein the block of the digital picture generated in step (b) is stored in a block buffer.

4. The method of claim 1 wherein step (a) comprises inputting the digital picture to a source buffer.

5. The method of claim 1 wherein step (c) comprises creating each of the weighting matrices according to number of filter taps, sampling precision, and an adjusted scaling factor.

6. The method of claim 5 wherein the adjusted scaling factor is a value selected from a group consisting of a scaling factor, a predetermined value, a first weight factor, and a product of the scaling factor and a second weight factor.

7. The method of claim 1 wherein the method further comprises determining pixel indices and applying boundary conditions before performing step (d).

8. The method of claim 1 wherein step (d) comprises following steps:
(e) multiplying the block of the digital picture by one of the weighting matrices to generate intermediate data; and
(f) multiplying the intermediate data by the other weighting matrix to generate output data.

9. The method of claim 8 wherein the method further comprises:
storing the intermediate data in an intermediate buffer; and
storing the output data in an destination buffer.

10. The method of claim 9 wherein steps (e) and (f) are repeated if more output data need be generated from the block in step (e).

11. A scaling device for scaling a digital picture, the scaling device comprising:
a source buffer for storing the digital picture;
a processing unit for creating two weighting matrices;
an intermediate buffer for storing intermediate data generated by multiplying a block of the digital picture by one of the weighting matrices; and
a destination buffer for storing output data generated by multiplying the intermediate data stored in the intermediate buffer by the other weighting matrix.

12. The scaling device in claim 11 wherein the processing unit comprises:
a plurality of first multipliers for multiplying each data of the block with a coefficient;
a plurality of first adders each connected with a group of first multipliers for adding up numbers generated by the group of first multipliers;
a plurality of second multipliers each connected with a first adder for multiplying number generated by the first adder with a coefficient; and
a second adder connected with the second multipliers for adding up numbers generated by the plurality of second multipliers.

13. The scaling device in claim 11 wherein the scaling device further comprises interpolation filters for filtering the digital picture so as to generate the block of the digital picture.

14. The scaling device in claim 13 wherein the scaling device further comprises a block buffer connected with the interpolation filters for storing the block of the digital picture.
